(19) United States
(12) Patent Application Publication
(10) Pub. No.: US 2013/0242538 A1
(43) Pub. Date: Sep. 19, 2013

(54) LED LIGHT BAR AND BACKLIGHT MODULE

(71) Applicant: Jianfa Huang, Shenzhen (CN)

(72) Inventor: Jianfa Huang, Shenzhen (CN)

(73) Assignee: SHENZHEN CHINA STAR OPTOELECTRONICS TECHNOLOGY CO LTD., Shenzhen (CN)

(21) Appl. No.: 13/501,629

(22) PCT Filed: Mar. 27, 2012
(86) PCT No.: PCT/CN12/73138

§ 371 Date: Apr. 12, 2012

(30) Foreign Application Priority Data
Mar. 13, 2012 (CN) 201210065129.1

(51) Int. Cl. G09F 13/04; F21V 21/00

(52) U.S. Cl. 362/97.1; 362/249.02

(57) ABSTRACT

The present invention relates to a LED light bar and a backlight module, which comprise at least one LED and a printed circuit board. The printed circuit board has an anode weld and a cathode weld disposed thereon. The anode weld has an insulating material disposed thereon. In conventional skills, electrostatic charges are likely to accumulate on the cathode weld, and thus the LED may be damaged by the electrostatic charges. In the present invention, the cathode weld has a high-reflective insulating material disposed thereon, and thereby it can efficiently prevent from being damaged by the electrostatic charges and low manufacture cost is achieved.

### TECHNICAL FIELD OF THE INVENTION

The present invention relates to display technology, and more particularly, to a LED (light emitting diode) light bar and a backlight module that are applicable to a display and capable of preventing from electrostatic discharge (ESD).

### BACKGROUND OF THE INVENTION

FIG. 1 is a schematic structural diagram showing a LED light bar that is applicable to a backlight module of a flat display in conventional skills. As shown in FIG. 1, a single LED is labeled as 101, a printed circuit board is labeled as 102, an anode weld is labeled as 103, and a cathode weld is labeled as 104. In general, the LED 101 of the LED light bard is welded to the anode weld 103 and the cathode weld 104 on the printed circuit board 102 by surface mounted technology. However, in the LED light bar operating environment, it is most likely to generate electrostatic charges, such as static charges on human body, static charges generated when films rubs with each other, static charges generated in the course of mechanical installation, and static charges inherently in dry air, which will cause damage to parts of LEDs 101 in the LED light bar.

In display technology, electrostatic discharge (i.e., so-called ESD) occupies 90% of the current LED damage situations. The LED damage process is primarily that the electrostatic charges are transmitted to electrodes of the LED and thus the LED is broken down or burned down by high voltages. When the electrostatic voltage is relatively low, the electrostatic charges are mainly transmitted to the cathode of the LED and thereby causing damage to the LED. When the electrostatic voltage exceeds 2000V, the LED may be directly damaged regardless that the electrostatic charges are transmitted to which one of the electrodes.

Recently, in order to ensure the reliability of the LED light bar, each LED 101 of the LED light bar will be connected to a zener diode in parallel for each LED inner part so as to prevent the LED 101 from being damaged by the electrostatic charges, causing damage over a large area. However, increasing the number of zener diodes will greatly increase the manufacture cost of the LED light bar, and this is a disadvantage of manufacture cost control in industry.

Therefore, in display technology, it is necessary to provide a LED light bar and a backlight module for solving the aforesaid problems in conventional skills.

### SUMMARY OF THE INVENTION

An objective of the present invention is to provide a LED light bar and a backlight module that are applicable to a display and have low cost, capable of possessing an excellent antistatic ability, for solving the problem of having less antistatic ability in a conventional LED light bar and backlight module.

Another objective of the present invention is to provide a LED light bar and a backlight module that are applicable to a display and have low cost, capable of possessing an excellent antistatic ability, for solving the problem of high manufacture cost of the LED light bar and the backlight module, caused by utilizing zener diodes to prevent LEDs from being damaged by electrostatic charges in conventional skills.

To achieve the above objectives, the present invention provides a LED light bar, which is applicable to a backlight module of a display, said LED light bar comprising: at least one LED; and a printed circuit board utilized for disposing the LED thereon; wherein the printed circuit board has an anode weld, a cathode weld, and an external connecting weld disposed thereon, the LED is electrically connected to the printed circuit board respectively via the anode weld and the cathode weld, the LED light bar is electrically connected to an external circuit via the external connecting weld, the cathode weld has an insulating material disposed thereon and covering a surface of the cathode weld, the anode weld has the insulating material disposed thereon and covering the surface of the anode weld, the external connecting weld has the insulating material disposed thereon and covering the surface of the external connecting weld.

In the LED light bar of the present invention, the printed circuit board has a solder mask disposed around the cathode weld and the anode weld, the insulating material disposed on the cathode weld and the anode weld comprises the solder mask.

In the LED light bar of the present invention, the insulating material is a high-reflective insulating material and the high-reflective insulating material is a white solder mask or a white high-temperature endurable insulating paint.

In the LED light bar of the present invention, the LED light bar further comprises a zener diode utilized for preventing the LED light bar from overdriving, wherein the zener diode and the LED are connected in parallel.

In the LED light bar of the present invention, a breakdown voltage of the zener diode is 1.2 to 2 times as big as a driving voltage of the LED light bar.

In another aspect, the present invention provides a LED light bar, which is applicable to a backlight module of a display, said LED light bar comprising: at least one LED; and a printed circuit board utilized for disposing the LED thereon; wherein the printed circuit board has an anode weld and a cathode weld disposed thereon, the LED is electrically connected to the printed circuit board respectively via the anode weld and the cathode weld, the cathode weld has an insulating material disposed thereon and covering a surface of the cathode weld.

In the LED light bar of the present invention, the anode weld has the insulating material disposed thereon.

In the LED light bar of the present invention, the printed circuit board has a solder mask disposed around the cathode weld and the anode weld, the insulating material disposed on the cathode weld and the anode weld comprises the solder mask.

In the LED light bar of the present invention, the printed circuit board further has an external connecting weld disposed thereon, the LED light bar is electrically connected to an external circuit via the external connecting weld, and the external connecting weld has the insulating material disposed thereon and covering the surface of the external connecting weld.

In the LED light bar of the present invention, the insulating material is a high-reflective insulating material and the high-reflective insulating material is a white solder mask or a white high-temperature endurable insulating paint.

In the LED light bar of the present invention, the LED light bar further comprises a zener diode utilized for preventing the LED light bar from overdriving, wherein the zener diode and the LED are connected in parallel.

In the LED light bar of the present invention, a breakdown voltage of the zener diode is 1.2 to 2 times as big as a driving voltage of the LED light bar.

In yet another aspect, the present invention provides a backlight module that is applicable to a display, said backlight module comprising a LED light bar serving as a light source, wherein the LED light bar of the backlight module comprises: at least one LED; and a printed circuit board utilized for disposing the LED thereon; wherein the printed circuit board has an anode weld and a cathode weld disposed thereon, the LED is electrically connected to the printed circuit board respectively via the anode weld and the cathode weld, the cathode weld has an insulating material disposed thereon and covering a surface of the cathode weld.

In the LED light bar of the present invention, the anode weld has the insulating material disposed thereon and covering the surface of the anode weld.

In the LED light bar of the present invention, the printed circuit board has a solder mask disposed around the cathode weld and the anode weld, the insulating material disposed on the cathode weld and the anode weld comprises the solder mask.

In the LED light bar of the present invention, the printed circuit board further has an external connecting weld disposed thereon, the LED light bar is electrically connected to an external circuit via the external connecting weld, and the external connecting weld has the insulating material disposed thereon and covering the surface of the external connecting weld.

In the LED light bar of the present invention, the insulating material is a high-reflective insulating material and the high-reflective insulating material is a white solder mask or a white high-temperature endurable insulating paint.

In the LED light bar of the present invention, the LED light bar further comprises a zener diode utilized for preventing the LED light bar from overdriving, wherein the zener diode and the LED are connected in parallel.

In the LED light bar of the present invention, a breakdown voltage of the zener diode is 1.2 to 2 times as big as a driving voltage of the LED light bar.

The LED light bar and the backlight module implemented according to the present invention have following beneficial effects. By disposing the insulating material on the welds, it can prevent the LED of the LED light bar from being damaged by electrostatic charges and meanwhile reduce the number of the zener diodes in use, thereby reducing the manufacture cost of the LED light bar and solving the problem of having less antistatic ability or high manufacture cost in a conventional LED light bar and backlight module.

To make above content of the present invention more easily understood, it will be described in details by using preferred embodiments in conjunction with the appending drawings.

### BRIEF DESCRIPTION OF THE DRAWINGS

FIG. 1 is a schematic structural diagram showing a LED light bar that is applicable to a backlight module of a flat display in conventional skills.

FIG. 2 is a schematic structural diagram showing a LED light bar that is applicable to a backlight module of a display according to a first preferred embodiment of the present invention.

FIG. 3 is a schematic structural diagram showing a LED light bar that is applicable to a backlight module of a display according to a second preferred embodiment of the present invention.

FIG. 4 is a schematic circuit structural diagram showing a LED light bar that is applicable to a backlight module of a display according to a preferred embodiment of the present invention.

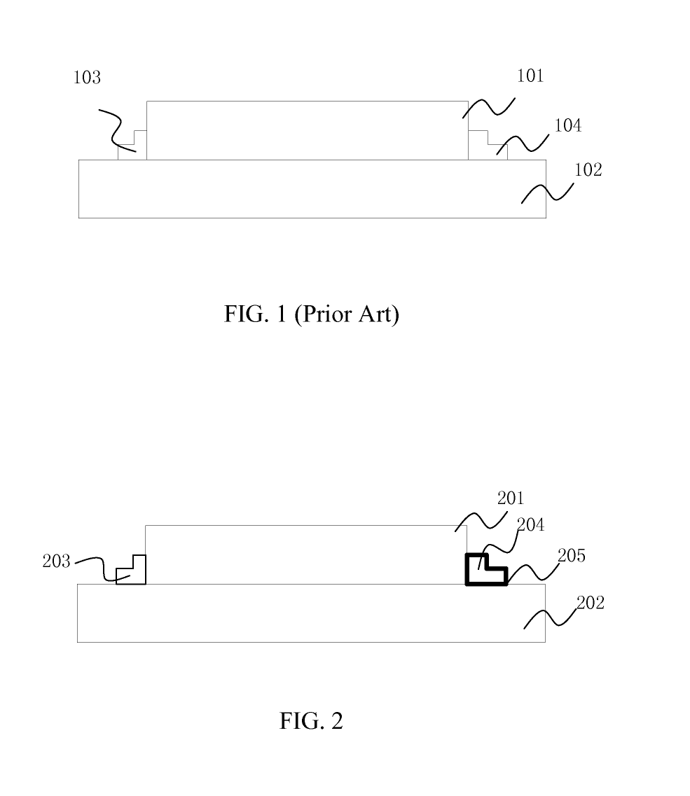

### DETAILED DESCRIPTION OF THE INVENTION

The following descriptions for the respective embodiments are specific embodiments capable of being implemented for illustrations of the present invention with referring to appended figures. The wordings of directions mentioned in the present invention, for example, the terms of up, down, front, rear, left, right, interior, exterior, side, etcetera, are merely directions of referring to appended figures. Therefore, the wordings of directions are employed for explaining and understanding the present invention but not limitations thereto. In addition, the elements with similar structures in the appended figures are represented by the same labels.

The inventors of the present invention carefully analyze how a LED (light emitting diode) light bar of a backlight module in display technology is damaged by electrostatic charges and how the electrostatic charges are generated. The following is the work completed by the inventors. The main reason why the electrostatic charges are generated in the backlight module is that a thin-film-transistor array substrate, a light guiding plate (LGP), and a reflection plate rub with each other. The electrostatic charges move in an irregular path via vibration, electrostatic induction, and etc. If the electrostatic charges are too close to a weld of a LED during their movement, the LED may be damaged by the electrostatic charges. It can sum up two types of destruction made by the electrostatic charges. The first is that the electrostatic charges are directly transmitted to an electrode of the LED via the weld and thus damages the LED. The second is that the LED is damaged by inductive charges that are generated via electrostatic induction.

Therefore, the present invention emphasizes on processing the LED light bar with an antistatic treatment so as to block the transmitting path of electrostatic charges, and thereby preventing the LED in the LED light bar from being damaged by the electrostatic charges. In addition, as the LED light bar is improved with an antistatic ability, the present invention also can make the LED light bar improving an ability to reflect light rays, and thus improving the light utilization ratio.

Referring to FIG. 2, FIG. 2 is a schematic structural diagram showing a LED light bar that is applicable to a backlight module of a display according to a first preferred embodiment of the present invention. The LED light bar comprises at least one LED 201 and a printed circuit board 202. The printed circuit board 202 is utilized for disposing the LED 201 thereon. The printed circuit board 202 has an anode weld 203, a cathode weld 204, and an external connecting weld (not shown) disposed thereon. The LED 201 is electrically connected to the printed circuit board 202 respectively via the anode weld 203 and the cathode weld 204. The LED light bar is electrically connected to an external circuit via the external connecting weld. The printed circuit board 202 also has a solder mask disposed around the anode weld 203, the cathode weld 204, and/or the external connecting weld. The solder mask is utilized for preventing the printed circuit board 202 from being damaged by a welding operation. After the LED 201 in the LED light bar of the present invention is connected to the printed circuit board 202, an insulating material 205 is disposed on the cathode weld 204 of the printed circuit board 202 and covers the surface of the cathode weld 204. Since the LED 201 is turned off upon a reverse current, the cathode of the LED 201 is much likely to endure a higher static voltage in the use of the LED light bar. By disposing the insulating material 205 on the cathode weld 204, the antistatic ability is improved in the use of the LED light bar.

Generally, the anode weld 203 and the cathode weld 204 used to weld the LED 201 of the LED light bar to the printed circuit board 202 are silvery gray and the reflection efficiency thereof is relatively low. In addition, the width of the light guiding plate is usually close to that of the LED light bar. The area occupied in the LED light bar by the anode weld 203 and the cathode weld 204 should not be neglected. Therefore, how to improve the light reflection efficiency of the LED light bar and every part on the printed circuit board 202 is very important for increasing light utilization ratio.

In the present invention, the insulating material 205 disposed on the welds of the LED light bar can be a high-reflective insulating material such as a white solder mask or a white high-temperature endurable insulating paint. The solder mask coated on the printed circuit board 202 around the anode weld 203 and the cathode weld 204 can be implemented by the aforesaid white solder mask. Since the area occupied by the welds is usually large (about 1/10 to ½ of the area covered by the solder mask), adopting a high-reflective and high-temperature endurable insulating material (about 100° C. endurable, the reflection rate greater than 80%) can avoid heat generated from the anode and the cathode of the LED affecting the reliability of the LED light bar. On the other hand, the high reflection characteristic improves light utilization ratio of the LED 201 (improving 5% in general).

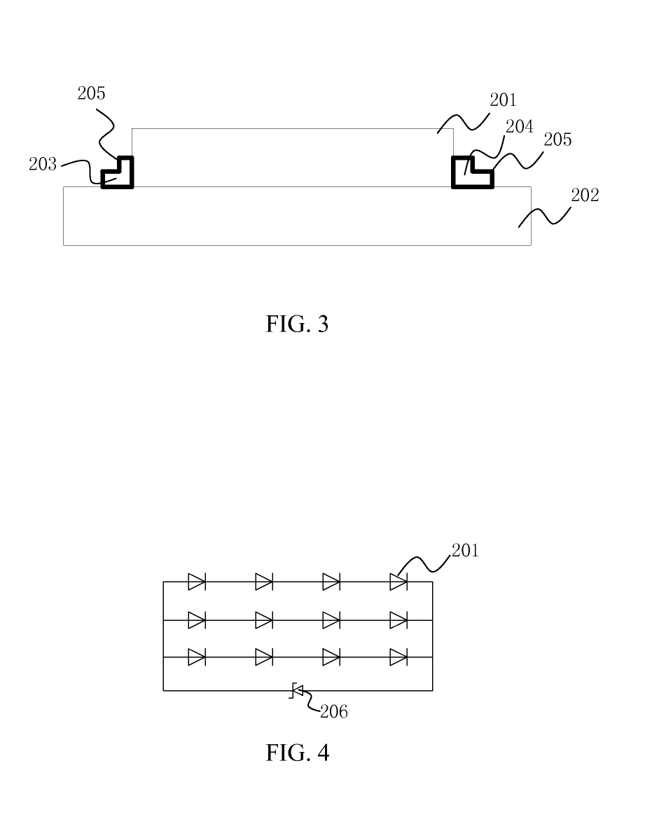

Referring to FIG. 3, FIG. 3 is a schematic structural diagram showing a LED light bar that is applicable to a backlight module of a display according to a second preferred embodiment of the present invention. The difference between the first preferred embodiment and the second preferred embodiment of the present invention is that the second preferred embodiment not only disposes the insulating material 205 on the cathode weld 204 of the printed circuit board 202 but also disposes the insulating material 205 on the anode weld 203 and/or the external connecting weld of the printed circuit board 205 to respectively cover the surfaces of anode weld 203 and/or the external connecting weld. This further improves the antistatic ability of the LED light bar and ensures the reliability of the LED light bar.

As being a further improvement of the LED light bar of the present invention as shown in FIG. 4, FIG. 4 is a schematic structural diagram showing a LED light bar according to a preferred embodiment of the present invention. The LED light bar further comprises a zener diode 206. The zener diode 206 is utilized to prevent the LED light bar from overdriving. The zener diode 206 is connected to all the LEDs 201 of the LED light bar in parallel. As shown in FIG. 4, the anode of the zener diode 206 is connected to the cathodes of all the LEDs 201 and the cathode of the zener diode 206 is connected to the anodes of all the LEDs 201. All the LEDs 201 form the LED light bar by being connected in series and/or in parallel. A breakdown voltage of the zener diode is 1.2 to 2 times as big as a driving voltage of the LED light bar.

During the LED light bar works, the LED light bar can function well when a voltage applied to two ends of the LED light bar is normal. When a forward voltage applied to the two ends of the LED light bar is too large and thus exceeds a breakdown voltage of the zener diode 206, the zener diode 206 will be broken down and turned to be conductive to a reverse current flow. Therefore, the forward voltage that is too large can be avoided being applied to the LEDs 201 of the LED light bar, causing the damage of the LEDs 201.

In the LED light bar of the present invention, not only the anode weld 203, the cathode weld 204, and/or the external connecting weld have the insulating material disposed thereon, but also all the LEDs 201 of the LED light bar are connected to one zener diode having a larger breakdown voltage in a parallel connection instead of connecting one LED 201 to a single zener diode in parallel for every one of them. The present invention can make the LED light bar possessing the antistatic ability, and meanwhile the manufacture of the LED light bar is simplified, the production efficiency is improved, the cost for manufacturing the LED light bar is reduced, for example, the material cost for purchasing the zener diode and the manufacture cost for using the zener diode, e.g., wire cost for bonding the zener diode. In addition, since the zener diode is usually black in color which may absorb light rays, the present invention adopts much fewer zener diodes such that the light utilization ratio of the LED 201 can be improved.

The present invention further relates to a backlight module that is applicable to a display. The backlight module comprises a LED light bar serving as a light source. The LED light bar comprises at least one LED and a printed circuit board. The printed circuit board is utilized for disposing the LED thereon. The printed circuit board has an anode weld, a cathode weld, and an external connecting weld disposed thereon. The LED is connected to the printed circuit board respectively via the anode weld and the cathode weld. The LED light bar is connected to an external circuit via the external connecting weld. In the LED light bar, the cathode weld on the printed circuit board has an insulating material disposed thereon. Referring to the afore-mentioned embodiments of the LED light bar, the working principles and beneficial effects of the backlight module of the present invention are the same as or similar to the afore-mentioned embodiments of the LED light bar.

Above all, by disposing the insulating material on the welds, the LED light bar and the backlight module of the present invention can prevent the LED of the LED light bar from being damaged by electrostatic charges and meanwhile reduce the number of the zener diodes in use, thereby reducing the manufacture cost of the LED light bar, improving light utilization ratio of the LED, and solving the problem of having less antistatic ability or high manufacture cost in a conventional LED light bar and backlight module.

While the preferred embodiments of the present invention have been illustrated and described in detail, various modifications and alterations can be made by persons skilled in this art. The embodiment of the present invention is therefore described in an illustrative but not restrictive sense. It is intended that the present invention should not be limited to the particular forms as illustrated, and that all modifications and alterations which maintain the spirit and realm of the present invention are within the scope as defined in the appended claims.

What is claimed is:

1. A LED light bar, which is applicable to a backlight module of a display, said LED light bar comprising:
at least one LED; and
a printed circuit board utilized for disposing the LED thereon;
wherein the printed circuit board has an anode weld, a cathode weld, and an external connecting weld disposed thereon, the LED is electrically connected to the printed circuit board respectively via the anode weld and the cathode weld, the LED light bar is electrically connected to an external circuit via the external connecting weld, the cathode weld has an insulating material disposed thereon and covering a surface of the cathode weld, the anode weld has the insulating material disposed thereon and covering the surface of the anode weld, the external connecting weld has the insulating material disposed thereon and covering the surface of the external connecting weld.

2. The LED light bar according to claim 1, wherein the printed circuit board has a solder mask disposed around the cathode weld and the anode weld, the insulating material disposed on the cathode weld and the anode weld comprises the solder mask.

3. The LED light bar according to claim 1, wherein the insulating material is a high-reflective insulating material and the high-reflective insulating material is a white solder mask or a white high-temperature endurable insulating paint.

4. The LED light bar according to claim 1, further comprising a zener diode utilized for preventing the LED light bar from overdriving, wherein the zener diode and the LED are connected in parallel.

5. The LED light bar according to claim 4, wherein a breakdown voltage of the zener diode is 1.2 to 2 times as big as a driving voltage of the LED light bar.

6. A LED light bar, which is applicable to a backlight module of a display, said LED light bar comprising:
at least one LED; and
a printed circuit board utilized for disposing the LED thereon;
wherein the printed circuit board has an anode weld and a cathode weld disposed thereon, the LED is electrically connected to the printed circuit board respectively via the anode weld and the cathode weld, the cathode weld has an insulating material disposed thereon and covering a surface of the cathode weld.

7. The LED light bar according to claim 6, wherein the anode weld has the insulating material disposed thereon.

8. The LED light bar according to claim 7, wherein the printed circuit board has a solder mask disposed around the cathode weld and the anode weld, the insulating material disposed on the cathode weld and the anode weld comprises the solder mask.

9. The LED light bar according to claim 6, wherein the printed circuit board further has an external connecting weld disposed thereon, the LED light bar is electrically connected to an external circuit via the external connecting weld, and the external connecting weld has the insulating material disposed thereon and covering the surface of the external connecting weld.

10. The LED light bar according to claim 6, wherein the insulating material is a high-reflective insulating material and the high-reflective insulating material is a white solder mask or a white high-temperature endurable insulating paint.

11. The LED light bar according to claim 6, further comprising a zener diode utilized for preventing the LED light bar from overdriving, wherein the zener diode and the LED are connected in parallel.

12. The LED light bar according to claim 11, wherein a breakdown voltage of the zener diode is 1.2 to 2 times as big as a driving voltage of the LED light bar.

13. A backlight module that is applicable to a display, said backlight module comprising a LED light bar serving as a light source, wherein the LED light bar of the backlight module comprises:
at least one LED; and
a printed circuit board utilized for disposing the LED thereon;
wherein the printed circuit board has an anode weld and a cathode weld disposed thereon, the LED is electrically connected to the printed circuit board respectively via the anode weld and the cathode weld, the cathode weld has an insulating material disposed thereon and covering a surface of the cathode weld.

14. The backlight module according to claim 13, wherein the anode weld has the insulating material disposed thereon and covering the surface of the anode weld.

15. The backlight module according to claim 14, wherein the printed circuit board has a solder mask disposed around the cathode weld and the anode weld, the insulating material disposed on the cathode weld and the anode weld comprises the solder mask.

16. The backlight module according to claim 13, wherein the printed circuit board further has an external connecting weld disposed thereon, the LED light bar is electrically connected to an external circuit via the external connecting weld, and the external connecting weld has the insulating material disposed thereon and covering the surface of the external connecting weld.

17. The backlight module according to claim 13, wherein the insulating material is a high-reflective insulating material and the high-reflective insulating material is a white solder mask or a white high-temperature endurable insulating paint.

18. The backlight module according to claim 13, wherein the LED light bar further comprises a zener diode utilized for preventing the LED light bar from overdriving, wherein the zener diode and the LED are connected in parallel.

19. The backlight module according to claim 18, wherein a breakdown voltage of the zener diode is 1.2 to 2 times as big as a driving voltage of the LED light bar.
